(19) United States
(12) Patent Application Publication
(10) Pub. No.: US 2026/0259786 A1
(43) Pub. Date: Sep. 3, 2026

(54) CONTEXT-BASED DEVICE POWER MANAGEMENT

(71) Applicant: Intel Corporation, Santa Clara, CA (US)

(72) Inventor: Rupesh THYAGARAJAN, Folsom, CA (US)

(21) Appl. No.: 19/630,599

(22) Filed: Mar. 27, 2026

(51) Int. Cl. G06F 9/50; G06F 1/28

(52) U.S. Cl. CPC G06F 9/5094; G06F 1/28

(57) ABSTRACT

Various aspects relate to methods and computing systems that implement closed-loop workload hint protocol bridging an operating system (OS) power manager and a power management controller (PMC). The OS power manager generates a structured workload hint encoding a plurality of workload-context parameters characterizing predicted idle behavior and transmits the hint to the PMC via a platform interface. The PMC dynamically adjusts a break-even threshold for selecting among a plurality of idle states based on a multi-factor function of the hint-derived parameters. Effectiveness telemetry is reported from the PMC back to the OS via a telemetry interface, enabling the OS to calibrate subsequent hint generation. A dual-layer prediction cross-validation architecture enables both the OS and the PMC to independently validate the hint using complementary information sources, with feedback-driven reclassification of activity classes for continuous enhancement.

### BACKGROUND

Modern computing platforms, particularly mobile and client devices, employ hierarchical low-power idle states to balance power savings with device responsiveness in terms of user experience. For example, while sub-200 millisecond response time for an interactive graphical application may provide a more-than-adequate user experience, a response delay of even a few milliseconds can cause a disruptive audio or video glitch. In architectures conforming to the Advanced Configuration and Power Interface (ACPI) specification, systems may support multiple idle sub-states within the S0 working state commonly designated S0i2 and S0i3. A shallow sub state such as S0i2 preserves most voltage rails and clock domains, yielding wake latencies on the order of a millisecond, but providing only modest power reduction. A deep sub state such as S0i3 removes most voltage rails and shuts down clock trees, achieving substantially lower power consumption at the cost of higher entry and exit energy and wake latencies on the order of tens of milliseconds.

A power management controller (PMC), typically implemented as firmware executing on a dedicated microcontroller within a SoC, is responsible for selecting which idle sub-state to enter when an operating system (OS) indicates that no useful work is pending. The PMC bases this selection on a break-even threshold (BET), which is a minimum idle duration at which the energy saved by residing in a deeper sub state exceeds the energy cost of entering and exiting that sub state. If the expected idle window is shorter than the BET, entry into the deeper sub state is counterproductive (in terms of power consumption) because the transition energy cost exceeds the savings. Existing systems have a propensity to enter into power saving states when it is not desirable and not to enter power saving states when it would be useful. Accordingly, there is a need for improved mechanisms for context-based power management.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the proposed configuration. In the following description, various aspects are described with reference to the following drawings, in which:

FIG. 1A is a block diagram illustrating a conventional system employing static break-even thresholds for idle-state selection, showing two failure modes associated with fixed thresholds;

FIG. 1B depicts a block diagram illustrating a system employing workload-adaptive break-even thresholds in various aspects, showing how workload context hints enable the PMC to raise or lower the threshold based on predicted idle behavior;

FIG. 2 depicts a data flow diagram illustrating an example workload hint protocol including hint generation, hint encoding, memory-mapped input/output (MMIO) transmission, threshold adjustment, S0ix state control, telemetry reporting, and feedback in various aspects;

FIG. 3 depicts a sequence diagram illustrating an example multi-stage hint submission and telemetry return flow between an operating system (OS) power manager, a device-specific configuration and power management interface, and power management controller (PMC) firmware in various aspects;

FIG. 4 depicts a field-layout diagram illustrating an example byte-level structure of a 16-byte workload hint data structure and field encoding definitions in various aspects;

FIG. 5 depicts an example decision matrix illustrating dual-layer prediction cross-validation between OS-side and PMC-side validation based on agreement or divergence between predicted idle duration and historical wake-interval average in various aspects;

FIG. 6 depicts a block diagram illustrating a PMC threshold adjustment engine receiving input conditions and producing idle-state decisions, including a break-even threshold formula, in various aspects;

FIG. 6A depicts a table summarizing example workload scenarios S1 through S5 with corresponding multiplier values, provisional break-even thresholds, and primary decisions in various aspects;

FIG. 6B is a table illustrating the derivation of the activity multiplier M_activity by policy mapping of hint-field tuples to activity classes in various aspects;

FIG. 7 depicts an example bar chart and accompanying table comparing power/performance enhancement scores under static thresholds versus adaptive hint-driven thresholds across several workload scenarios in various aspects; and

FIG. 8 depicts an example circular flow diagram illustrating the closed-loop continuous enhancement cycle comprising hint submission, threshold control, metric recording, and prediction adaptation in various aspects.

### DESCRIPTION

The following detailed description refers to the accompanying drawings that show, by way of illustration, exemplary details and embodiments in which aspects of the present disclosure may be practiced. The word “exemplary” is used herein to mean “serving as an example, instance, or illustration”. Any embodiment or design described herein as “exemplary” is not necessarily to be construed as preferred or advantageous over other embodiments or designs. Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, central processing unit (CPU), graphics processing unit (GPU), digital signal processor (DSP), field programmable gate array (FPGA), integrated circuit, application specific integrated circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, three-dimensional, among others, or any combination thereof. Registers, shift registers, processor registers, data buffers, among others, are also embraced herein by the term memory. The term “software” refers to any type of executable instruction, including firmware.

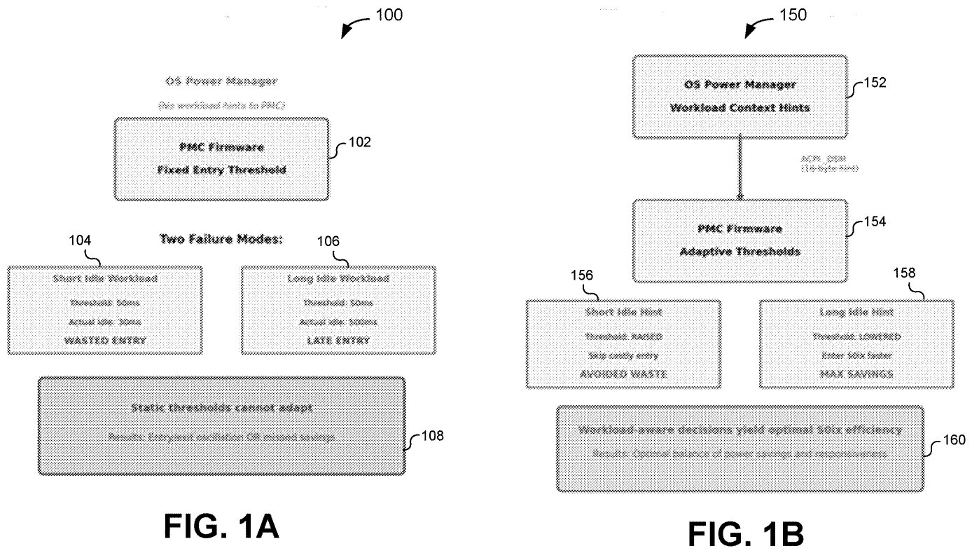

FIG. 1A illustrates a conventional system 100 employing static break-even thresholds. An operating system power manager provides no workload hints to the PMC. The PMC firmware 102 applies a fixed entry threshold for idle-state selection. This static approach produces two failure modes. In a first failure mode 104 (short idle workload), the fixed threshold (e.g., 50 ms) is greater than the actual idle duration (e.g., 30 ms actual idle), resulting in a wasted entry: the system pays the energy cost of deep-state entry and exit but resides in the deep state too briefly to recoup the investment. In a second failure mode 106 (long idle workload), the same fixed threshold delays entry into the deep state (e.g., actual idle of 500 ms far exceeds the threshold), resulting in late entry: the system misses substantial power savings during the early portion of the idle window. As summarized at 108, static thresholds cannot adapt to workload variation, resulting in entry/exit oscillation or missed savings.

In conventional systems, the PMC determines the BET using reactive, hardware-local signals. Such hardware-local signals may include latency tolerance reporting (LTR) values from PCIe and USB endpoints, historical residency statistics accumulated by the PMC itself, and fixed timing thresholds established at build time or during BIOS configuration. In such systems, the OS has no mechanism to communicate forward-looking workload context to the PMC.

This information asymmetry produces several failure modes in addition to those illustrated in FIG. 1A. During sustained low-activity periods such as user absence, the PMC may remain in shallow idle states because historical data suggests continued activity, wasting energy. During brief idle intervals when user activity is expected to resume promptly, the PMC may enter deep states based on aggregate statistics, causing perceptible latency upon wake, such as audio or video glitches. During extended absences spanning days, the PMC may rely on historical weekday activity patterns, missing opportunities for deeper power savings when the device will remain unused for prolonged durations.

Existing approaches such as static break-even thresholds, user-selected power profiles, and binary idle-active signaling from connected standby frameworks fail to address a fundamental problem: the OS possesses workload-level semantic context, i.e., scheduler queue depths, user-presence signals, application activity classifications, battery urgency, that are invisible to the PMC. The present teachings provide a protocol to convey such context together with a feedback mechanism for continuous improvement.

FIG. 1B illustrates a system 150 employing workload-adaptive break even thresholds in accordance with various aspects. In contrast to conventional system 100 of FIG. 1A, the system 150 introduces a bidirectional communication path between OS power manager 152 and PMC firmware 154. OS power manager 152 generates workload context hints that encode forward-looking predictions of idle behavior derived from system state conditions observable by the OS but not independently observable by the PMC. The workload context hints are transmitted from OS power manager 152 to PMC firmware 154 via a platform interface, shown illustratively as an ACPI_DSM carrying a hint payload. PMC firmware 154 may then apply adaptive thresholds that are dynamically adjusted based on received workload context hints, rather than relying on a fixed entry threshold as done by conventional system 100.

Two representative hint-driven outcomes are shown. In a first outcome 156, a short idle hint indicates that the expected idle window will be brief. In response, PMC firmware 154 raises break-even threshold, causing the system to skip costly deep-state entry. This avoids a wasted entry failure mode as illustrated at 104 in FIG. 1A, where the system would otherwise pay the energy costs of deep state entry and exit without sufficient idle residency to recoup the investment. In a second outcome 158, a long idle hint indicates that a sustained idle is expected. In response, PMC firmware 154 lowers a break-even threshold, enabling faster entry into a deeper state, thereby increasing power savings. This avoids the late entry failure mode illustrated at 106 in FIG. 1A, where the system would otherwise remain in a shallow state during the early portion of a long idle window, missing substantial power savings. As summarized at 160, workload aware decisions made possible by the adaptive threshold protocol yield an improved balance of power savings and responsiveness, in contrast to the exit entry oscillation or missed savings that would result from the static thresholds of the conventional system 100.

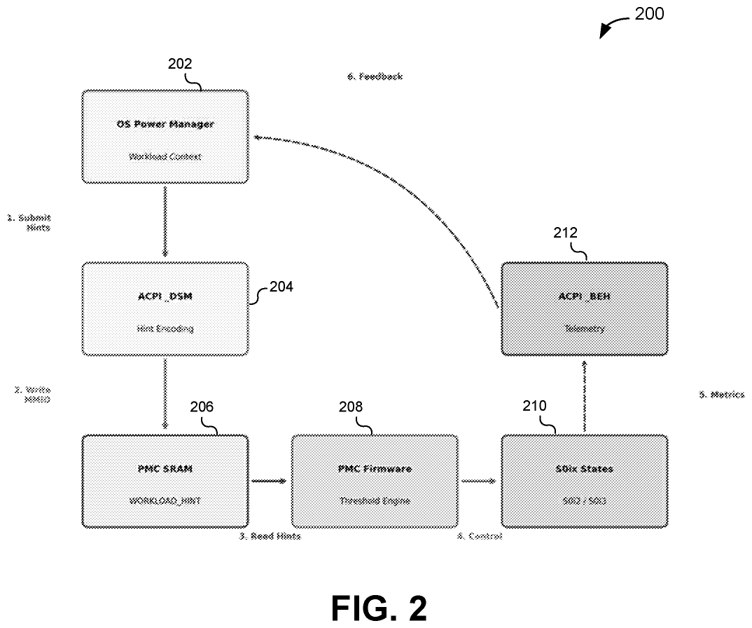

FIG. 2 illustrates a workload hint protocol 200 in various aspects. Protocol 200 defines a closed-loop data path connecting an OS power manager 202, a platform interface layer, controller-accessible memory, PMC firmware, S0ix state control, and a telemetry return path. The OS power manager 202 maintains workload context derived from monitoring system-state conditions such as scheduler queue depths, user-presence signals, peripheral activity, network traffic, and battery state, for example.

In a first stage (stage 1, “Submit Hints”), the OS Power Manager 202 generates a structured workload hint encoding a plurality of workload-context parameters and submits the hint to ACPI _DSM interface 204. ACPI _DSM interface 204 performs hint encoding and, in a second stage (stage 2, “Write MMIO”), writes the encoded hint as a 16-byte payload to a PMC static random access memory (SRAM) region 206. The PMC SRAM region 206 may contain a WORKLOAD_HINT mailbox allocated to receive the structured hint. In a third stage (stage 3, “Read Hints”), PMC firmware 208 operating a threshold engine reads the hint data from the PMC SRAM region 206. In a fourth stage (stage 4, “Control”), the PMC firmware 208 applies the hint-derived parameters to dynamically adjust the break-even threshold and controls S0ix state selection, causing the system to enter an appropriate idle state among the S0ix states 210 (e.g., S0i2 or S0i3). In a fifth stage (stage 5, “Metrics”), an ACPI break even hint (ACPI_BEH) telemetry interface 212 exposes effectiveness metrics accumulated by PMC firmware 208. In a sixth stage (stage 6, “Feedback”), the effectiveness metrics are returned to the OS Power Manager 202, closing the enhancement loop and enabling the OS Power Manager 202 to calibrate its hint-generation algorithm based on actual idle-state outcomes.

A platform interface between the OS power manager 202 and the PMC SRAM region 206 may be implemented using any suitable mechanism for conveying data from the OS to the PMC. As shown in FIG. 2, a platform interface may include ACPI _DSM interface 204 identified by a vendor-specific universally unique identifier (UUID). In alternative aspects, the platform interface may comprise a direct memory-mapped input/output (MMIO) write path, a sideband communication channel, a vendor-specific firmware interface, or any other mechanism capable of transferring a structured data payload from OS-accessible address space to controller-accessible memory. The present teachings are not limited to any particular transport mechanism. Similarly, the telemetry return path may be implemented via ACPI_BEH telemetry interface 212 as shown, or via a shared memory region polled by the OS, an interrupt-driven notification, or any other suitable return channel. The present teachings are not limited to any particular telemetry transport.

### Hint Submission Sequence

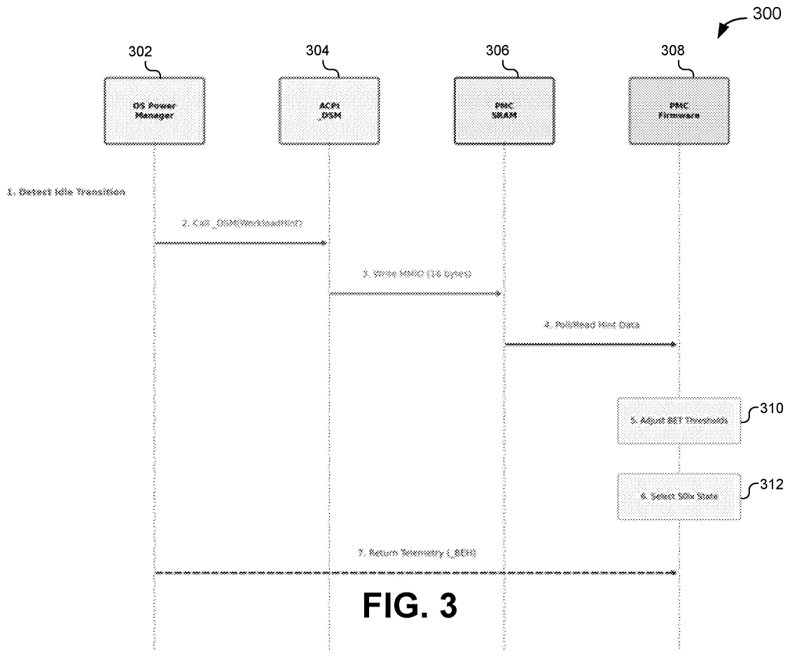

FIG. 3 illustrates an example hint submission sequence 300 in various aspects, showing interactions among multiple entities: an OS Power Manager 302, an ACPI _DSM interface 304, PMC SRAM 306, and PMC firmware 308. The sequence comprises multiple stages. In stage 1 (“Detect Idle Transition”), the OS Power Manager 302 detects that the processor is entering an idle state, for example via an idle callback from a CPU idle framework associated with an operating system kernel such as an OS power framework (PoFx). In stage 2 (“Call _DSM(WorkloadHint)”), OS power manager 302 may invoke an ACPI_DSM method, passing the structured workload hint as an argument. In stage 3 (“Write MMIO (16 bytes)”), ACPI_DSM interface 304 writes the 16-byte workload hint to the PMC SRAM 306 via a memory-mapped I/O write. In stage 4 (“Poll/Read Hint Data”), the PMC firmware 308 detects the write and reads the hint data from the PMC SRAM 306.

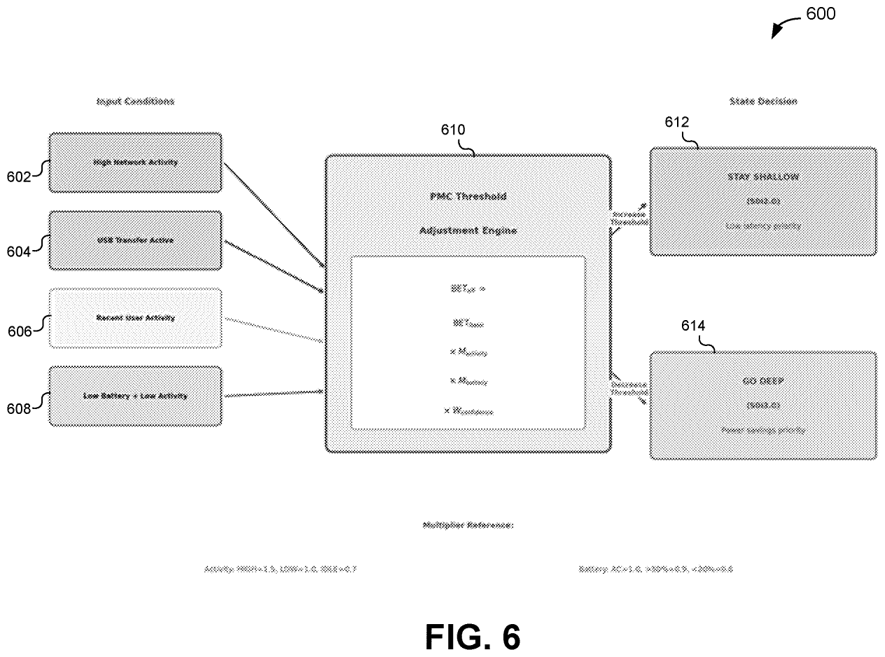

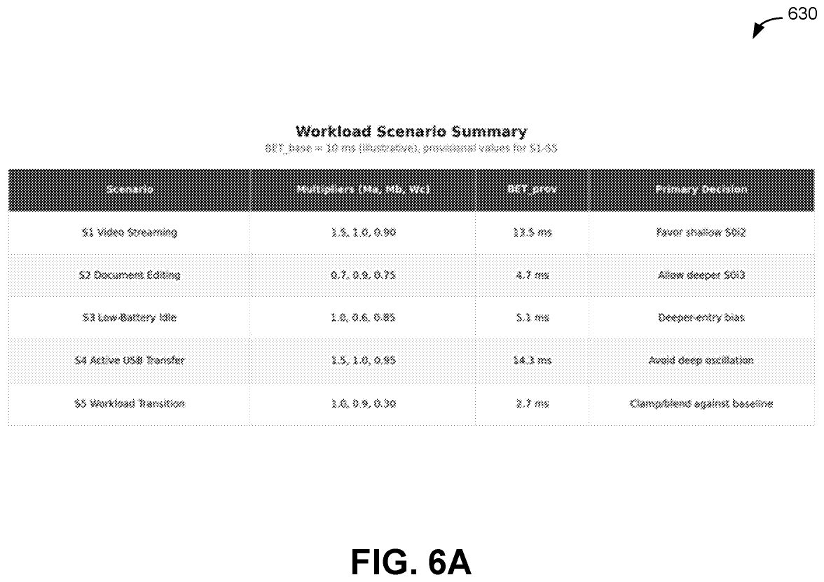

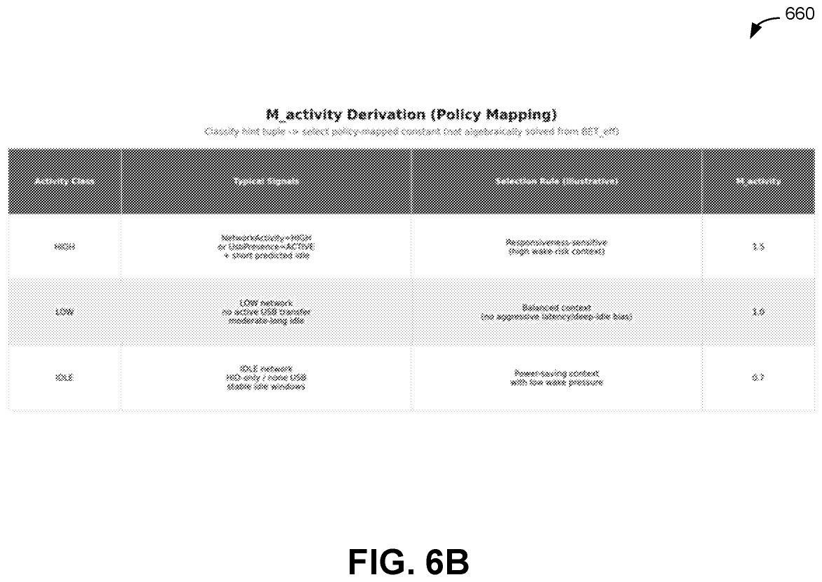

In stage 5 (“Adjust BET Thresholds”) 310, the PMC firmware 308 applies the hint-derived parameters to dynamically compute an effective break-even threshold using the multi-factor adjustment algorithm described below with reference to FIG. 6. In stage 6 (“Select S0ix State”) 312, the PMC firmware 308 compares the available idle window duration against the adjusted threshold and selects the appropriate idle-state depth (e.g., S0i2 or S0i3). In stage 7 (“Return Telemetry (_BEH)”), the PMC firmware 308 makes effectiveness telemetry available via the ACPI_BEH method, shown as a dashed return line to the OS power manager 302.

The hint submission may be triggered by one or more of the following events: each OS idle entry transition (as shown in FIG. 3), a determination that hint content has changed since the last transmission, or expiration of a periodic timer. In various aspects, OS power manager 302 employs a combination of these triggers, transmitting on every idle entry during active workloads and falling back to periodic transmission during sustained idle periods. The present teachings encompass any triggering policy or combination thereof.

### Hint Generation

OS power manager 202 (FIG. 2), also shown as OS power manager 302 in FIG. 3, monitors a plurality of system-state conditions to construct a structured workload hint. Each condition may capture an aspect of system state that is observable by the OS but not independently observable by the PMC through its own hardware telemetry. The hint thereby bridges the information asymmetry between the OS and the PMC.

In various aspects, structured workload hints may comprise the following parameters, though the present teachings are not limited to this particular set: a network activity indicator encoding a classification of current network traffic intensity; a peripheral presence indicator encoding the type and activity state of attached peripheral devices; a display state indicator encoding the current state of the display subsystem as a proxy for user presence; a battery context indicator encoding current power source and battery capacity state; a predicted idle duration comprising a forward-looking estimate of the expected idle window derived from OS scheduler state including timer-coalescing queues and process-scheduling information; a historical wake-interval average comprising a backward-looking rolling average of observed wake-to-wake intervals over a recent activity window; and a confidence indicator comprising the OS's self-assessment of the reliability of the predicted idle duration.

The confidence indicator reflects a self-assessment performed by the OS power manager. Specifically, the OS power manager compares the predicted idle duration against the historical wake-interval average. When these values diverge significantly, indicating a workload phase change, bursty interrupt source, or cold-start condition, the OS power manager reduces the confidence indicator accordingly. The confidence indicator thus incorporates the OS's own assessment of prediction-versus-history agreement before the hint is transmitted.

### Workload Hint Data Structure

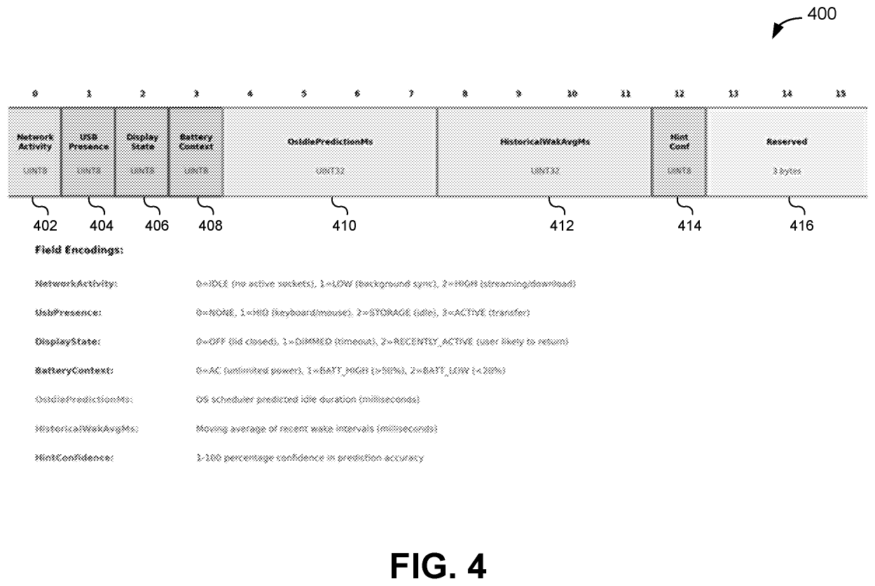

FIG. 4 illustrates the byte-level layout of a WORKLOAD_HINT data structure 400 in accordance with various aspects. Data structure 400 may be implemented as a 16-byte structure designed for minimal overhead while providing semantically rich workload context. The 16 bytes may be organized as follows. Byte 0 contains a NetworkActivity field 402, encoded as a UINT8. The NetworkActivity field 402 classifies network traffic intensity: a value of 0 indicates IDLE (no active sockets), a value of 1 indicates LOW (background sync), and a value of 2 indicates HIGH (streaming/download).

Byte 1 contains a UsbPresence field 404, encoded as a UINT8. The UsbPresence field 404 classifies attached USB peripheral activity: a value of 0 indicates NONE, a value of 1 indicates HID (keyboard/mouse), a value of 2 indicates STORAGE (idle), and a value of 3 indicates ACTIVE (transfer in progress). Byte 2 contains a DisplayState field 406, encoded as a UINT8. The DisplayState field 406 encodes the display subsystem state as a proxy for user presence: a value of 0 indicates OFF (lid closed), a value of 1 indicates DIMMED (timeout), and a value of 2 indicates RECENTLY_ACTIVE (user likely to return).

Byte 3 contains a BatteryContext field 408, encoded as a UINT8. The BatteryContext field 408 encodes the power source and remaining capacity: a value of 0 indicates AC (unlimited power), a value of 1 indicates BATT_HIGH (greater than 50% remaining), and a value of 2 indicates BATT_LOW (less than 20% remaining). Bytes 4 through 7 contain an OsIdlePredictionMs field 410, encoded as a UINT32. The OsIdlePredictionMs field 410 carries the OS scheduler's predicted idle duration in milliseconds, derived from timer-coalescing queues and process-scheduling information.

Bytes 8 through 11 contain a HistoricalWakeAvgMs field 412, encoded as a UINT32. The HistoricalWakeAvgMs field 412 carries a moving average of recent wake-to-wake intervals in milliseconds, providing a backward-looking ground truth that the PMC can use for cross-validation. Byte 12 contains a HintConfidence field 414, encoded as a UINT8. The HintConfidence field 414 carries a percentage value in the range 1-100 representing the OS's self-assessed confidence in prediction accuracy. Bytes 13 through 15 comprise a reserved region 416 (3 bytes) for future extension.

The specific field widths, byte positions, data types, and encoding values described above are illustrative. In alternative aspects, the workload hint data structure may comprise different fields, different data types, different encoding schemes, or a different total structure size. Benefits of the present teachings relate to a structured communication of a plurality of workload-context parameters from an OS to a PMC, not in a particular binary layout.

### Dual-Layer Prediction Cross-Validation

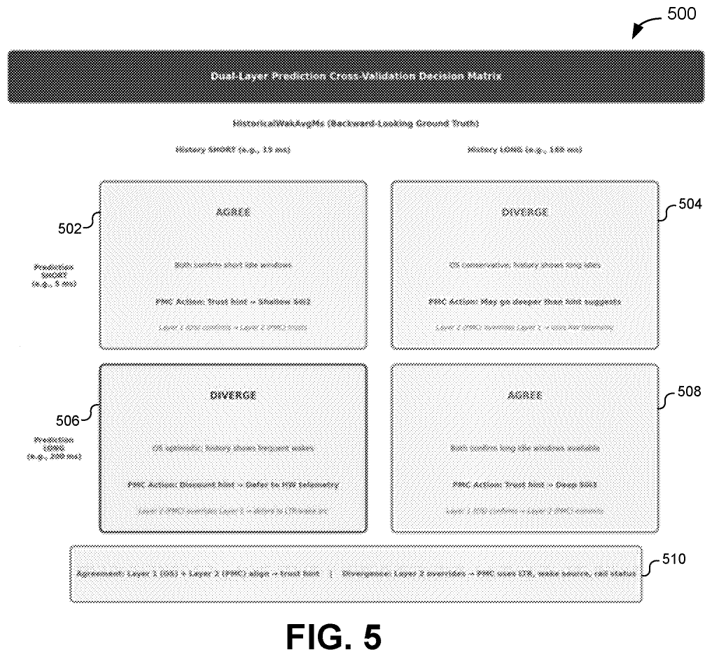

FIG. 5 illustrates an example dual-layer prediction cross-validation decision matrix 500 in various aspects. The protocol deliberately transmits both the raw HistoricalWakeAvgMs field 412 (FIG. 4) and the OS's interpreted HintConfidence field 414 rather than a single pre-digested value. This design enables two complementary validation layers. Layer 1 (OS-side self-assessment): The OS Power Manager compares its forward-looking predicted idle duration (OsIdlePredictionMs) against its own historical wake-interval average (HistoricalWakeAvgMs). When these diverge—indicating a workload phase change, bursty interrupt source, or cold-start condition—the OS reduces the HintConfidence accordingly. The HintConfidence thus already incorporates the OS's self-assessment of prediction reliability.

Layer 2 (PMC-side hardware-aware validation): The PMC firmware possesses context that the OS cannot access, including: (a) the BET_base lookup table containing actual entry/exit transition energy costs per state pair indexed by hardware platform variant; (b) real-time LTR values from PCIe and USB endpoints indicating imminent wake constraints that the OS has not yet been notified about; (c) current voltage rail and power-domain status; and (d) hardware-level wake-source attribution identifying which specific device endpoint triggered recent wakes. The PMC uses the raw HistoricalWakeAvgMs in conjunction with its own hardware telemetry to independently assess the plausibility of the OS prediction.

Decision matrix 500 defines four quadrants based on the relationship between the OsIdlePredictionMs (forward-looking prediction) and the HistoricalWakeAvgMs (backward-looking ground truth). In a first quadrant 502 (Prediction SHORT, History SHORT—AGREE), both signals confirm short idle windows. Both Layer 1 (OS) and Layer 2 (PMC) agree, and the PMC trusts the hint to select a shallow idle state such as S0i2. In a second quadrant 504 (Prediction SHORT, History LONG—DIVERGE), the OS predicts a short idle but historical data shows long idles. The OS is being conservative, and the PMC's Layer 2 may override Layer 1 to go deeper than the hint suggests, using its hardware telemetry to confirm the opportunity. In a third quadrant 506 (Prediction LONG, History SHORT—DIVERGE), the OS predicts a long idle but history shows frequent wakes. The OS is being optimistic, and the PMC's Layer 2 discounts the hint and defers to hardware telemetry such as LTR values and wake-source data. In a fourth quadrant 508 (Prediction LONG, History LONG—AGREE), both signals confirm long idle windows available. Both layers agree, and the PMC trusts the hint to select a deep idle state such as S0i3. A summary bar 510 indicates that when the layers agree, the hint is trusted; when they diverge, Layer 2 (PMC) overrides using LTR, wake source, and rail status.

### Break-Even Threshold Adjustment

FIG. 6 illustrates an example break-even threshold adjustment engine 600 in various aspects. The adjustment engine 600 receives a plurality of input conditions derived from the structured workload hint and produces an idle-state decision. Four representative input conditions are shown: a high network activity condition 602, a USB transfer active condition 604, a recent user activity condition 606, and a low battery combined with low activity condition 608. These input conditions feed into a PMC Threshold Adjustment Engine 610.

The PMC Threshold Adjustment Engine 610 maintains a base break-even threshold (BET_base) representing the minimum idle duration at which transitioning to a target idle substate saves more energy than the entry and exit transitions consume. BET_base may be stored in a lookup table indexed by source-state and destination-state pairs, with distinct entries per hardware platform variant. For illustrative purposes, BET_base=10 ms is used throughout this description; actual values are characterized per platform and may range from hundreds of microseconds (shallow substates) to tens of milliseconds (deep substates with voltage rail removal).

The PMC Threshold Adjustment Engine 610 computes an effective break-even threshold (BET_eff) by applying a multi-factor function to BET_base. As shown in FIG. 6, the function is: BET_eff=BET_base×M_activity×M_battery×W_confidence, where M_activity is an activity multiplier derived from activity-related hint parameters, M_battery is a battery multiplier derived from the BatteryContext field 408 (FIG. 4), and W_confidence is a confidence weight derived from the HintConfidence field 414 (FIG. 4).

When the computed BET_eff is increased (e.g., due to high network activity 602 or active USB transfer 604), the threshold rises and the system favors a STAY SHALLOW decision 612, selecting S0i2.0 with low latency priority. When the computed BET_eff is decreased (e.g., due to low battery with low activity 608), the threshold falls and the system favors a GO DEEP decision 614, selecting S0i3.0 with power savings priority.

The effective threshold BET_eff may be further subject to clamping to PMC policy bounds: BET_eff=clamp(BET_prov, BET_min, BET_max), where BET_prov is the provisional threshold computed by the formula, and BET_min and BET_max are platform-configured policy limits. When the HintConfidence field 414 falls below a policy threshold, the PMC firmware may additionally blend BET_eff with a hardware-derived baseline threshold before committing the final value for state selection. This blending ensures that unreliable OS predictions do not drive aggressive state transitions.

FIG. 6 further includes a multiplier reference showing illustrative values: M_activity may take values such as HIGH=1.5, LOW=1.0, and IDLE=0.7; M_battery may take values such as AC=1.0, >50%=0.9, and <20%=0.6. These values are illustrative and may be adjusted per platform policy. In alternative aspects, the multi-factor function may be additive, may employ a weighted sum, may use a lookup table indexed by combinations of hint parameter values, or may employ any other suitable mathematical combination of hint-derived parameters. Benefits of the present teachings involve a dynamic adjustment of a break-even threshold as a function of a plurality of OS-provided workload-context parameters, not in a particular mathematical formulation.

### Activity Multiplier and Adaptive Classification

FIG. 6B illustrates an example derivation of the activity multiplier M_activity by policy mapping in various aspects. A table 660 maps hint-field tuples to activity classes and corresponding multiplier values. Three activity classes are shown. A HIGH activity class corresponds to typical signals of NetworkActivity=HIGH or UsbPresence=ACTIVE combined with short predicted idle; the selection rule characterizes responsiveness-sensitive contexts with high wake-risk, and the associated M_activity value is 1.5. A LOW activity class corresponds to LOW network traffic, no active USB transfer, and moderate-to-long idle; the selection rule characterizes balanced contexts with no aggressive latency or deep-idle bias, and the associated M_activity value is 1.0. An IDLE activity class corresponds to IDLE network, HID-only or no USB, and stable idle windows; the selection rule characterizes power-saving contexts with low wake pressure, and the associated M_activity value is 0.7.

M_activity is a policy-mapped constant selected by classifying the hint-field tuple into an activity class; it is not solved algebraically from BET_eff. The classification maps each combination of activity-related parameters (NetworkActivity, UsbPresence, DisplayState, and optionally OsIdlePredictionMs) to one of the activity classes, and each activity class is associated with a predetermined multiplier value.

In various aspects, classification boundaries may be adaptive. The OS Power Manager, the PMC firmware, or both, adjust the mapping from hint-parameter combinations to activity classes based on effectiveness telemetry. This feedback-driven reclassification process operates as follows: the telemetry module reports, for each activity class, the rate of correct predictions (i.e., instances where the selected idle state matched actual idle duration) and the rate of misclassifications (i.e., instances where the system remained in a shallow state when deep entry would have been beneficial, or entered a deep state when a shallow state was needed). When the misclassification rate for a particular activity class exceeds a policy threshold, the classification boundary between that class and an adjacent class is adjusted in the direction that would have reduced the misclassification. Over successive feedback cycles, the classification may converge toward boundaries that minimize misclassification for the observed workload distribution.

In various aspects, associated adaptive reclassification may be performed at fleet scale. Effectiveness telemetry from a population of devices may be aggregated by an analytics service, and updated classification boundaries distributed to individual devices via firmware update, OS policy update, or configuration parameter adjustment.

### Illustrative Workload Scenarios

FIG. 6A illustrates an example workload scenario summary table 630 in various aspects, showing five representative scenarios (S1 through S5) with an illustrative BET_base of 10 ms. Each row lists the scenario name, the multiplier triplet (M_activity, M_battery, W_confidence), the resulting provisional threshold BET_prov, and the primary decision. Scenario S1 (Video Streaming): The OS reports high network activity, a recently active display, and very short predicted idle windows (e.g., 5 ms between frame decodes) with high confidence (0.90). The multipliers are M_activity=1.5 (HIGH class per FIG. 6B), M_battery=1.0 (AC power), W_confidence=0.90. BET_prov=10×1.5×1.0×0.90=13.5 ms. The primary decision is to favor shallow S0i2, keeping the SoC responsive to avoid frame drops from deep-state wake latency.

Scenario S2 (Document Editing): The OS reports idle network, HID-only peripherals, and moderate predicted idle windows (e.g., 200 ms between keystrokes) with moderate confidence (0.75). The multipliers are M_activity=0.7 (IDLE class per FIG. 6B), M_battery=0.9 (battery >50%), W_confidence=0.75. BET_prov=10×0.7×0.9×0.75=4.7 ms. The primary decision is to allow deeper S0i3 entry during inter-keystroke gaps, saving power while the ~50 ms wake latency is negligible relative to the 200 ms idle window.

Scenario S3 (Low-Battery Idle): The OS reports low network activity, a dimmed display, and a long predicted idle window with battery critically low. The multipliers are M_activity=1.0 (LOW class per FIG. 6B), M_battery=0.6 (battery <20%), W_confidence=0.85. BET_prov=10×1.0×0.6×0.85=5.1 ms. The primary decision is a deeper-entry bias, maximizing S0i3 residency to extend remaining battery life.

Scenario S4 (Active USB Transfer): The OS reports idle network, a recently active display, active USB transfer, and AC power. The multipliers are M_activity=1.5 (HIGH class per FIG. 6B, due to active USB), M_battery=1.0, W_confidence=0.95. BET_prov=10×1.5×1.0×0.95=14.3 ms. The primary decision is to avoid deep oscillation, preventing repeated S0i2/S0i3 transitions during the transfer that would degrade I/O throughput.

Scenario S5 (Workload Transition): The user has just switched workload types and the OS scheduler has not accumulated sufficient history. The multipliers are M_activity=1.0 (LOW class), M_battery=0.9, W_confidence=0.30. BET_prov=10×1.0×0.9×0.30=2.7 ms. The primary decision is to clamp/blend against baseline: the low confidence weight attenuates the hint toward zero, causing the PMC to fall back toward its own hardware-derived baseline rather than trusting the uncertain hint. As the OS accumulates more idle samples in the new workload pattern, HintConfidence rises and the hint gradually takes full effect.

The confidence weight W_confidence serves as a trust factor governing how strongly the OS hint influences the PMC's threshold decision. High confidence (W_confidence≈0.9-1.0) indicates a stable workload where the OS has accumulated sufficient idle-pattern history—the hint fully modulates BET_eff (Scenarios S1 and S4). Moderate confidence (W_confidence≈0.7-0.85) reflects workloads with some variability (Scenarios S2 and S3)—the hint influences but does not dominate. Low confidence (W_confidence<0.5) occurs during workload transitions or cold starts (Scenario S5)—the hint is attenuated toward zero, allowing the PMC's hardware telemetry to prevail until the OS regains predictive accuracy.

### Comparative Analysis

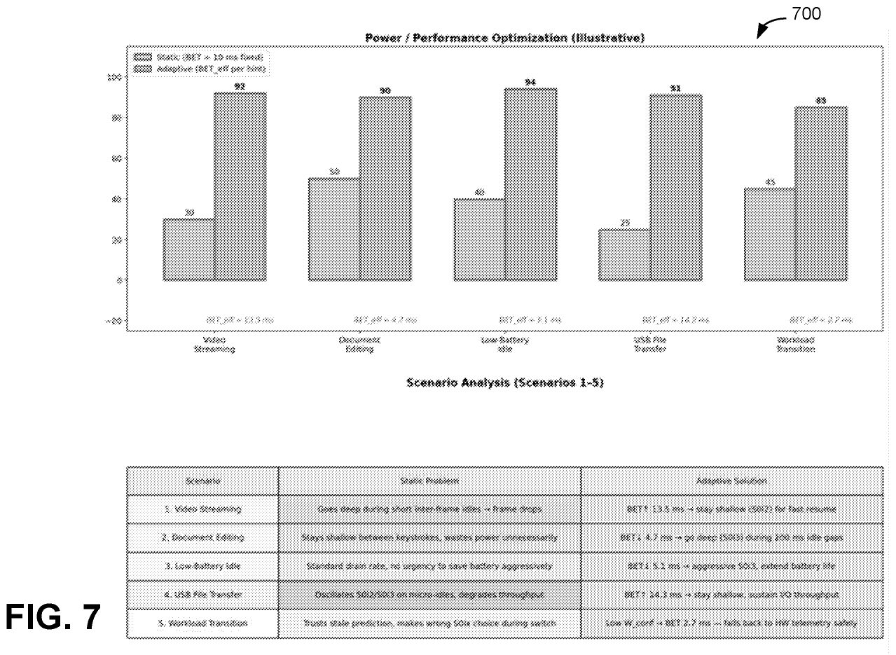

FIG. 7 illustrates a comparative analysis 700 in accordance with various aspects. A bar chart compares power/performance enhancement scores under static thresholds (BET=10 ms fixed) versus adaptive hint-driven thresholds (BET_eff per hint) across the five workload scenarios S1 through S5. For each scenario, the adaptive approach achieves substantially higher enhancement scores than the static approach. The BET_eff values shown beneath each scenario pair correspond to those computed in FIG. 6A.

An accompanying table in FIG. 7 summarizes the static problem and adaptive solution for each scenario. In Scenario 1 (Video Streaming), the static problem is that the system goes deep during short inter-frame idles causing frame drops; the adaptive solution raises BET to 13.5 ms to stay shallow in S0i2 for fast resume. In Scenario 2 (Document Editing), the static problem is that the system stays shallow between keystrokes wasting power unnecessarily; the adaptive solution lowers BET to 4.7 ms to go deep in S0i3 during 200 ms idle gaps. In Scenario 3 (Low-Battery Idle), the static problem is a standard drain rate with no urgency to save battery aggressively; the adaptive solution lowers BET to 5.1 ms for aggressive S0i3 to extend battery life. In Scenario 4 (USB File Transfer), the static problem is oscillation between S0i2/S0i3 on micro-idles degrading throughput; the adaptive solution raises BET to 14.3 ms to stay shallow and sustain I/O throughput. In Scenario 5 (Workload Transition), the static problem is trusting stale predictions during a workload switch; the adaptive solution reduces BET to 2.7 ms with low confidence, falling back to hardware telemetry safely.

### Closed-Loop Continuous Enhancement

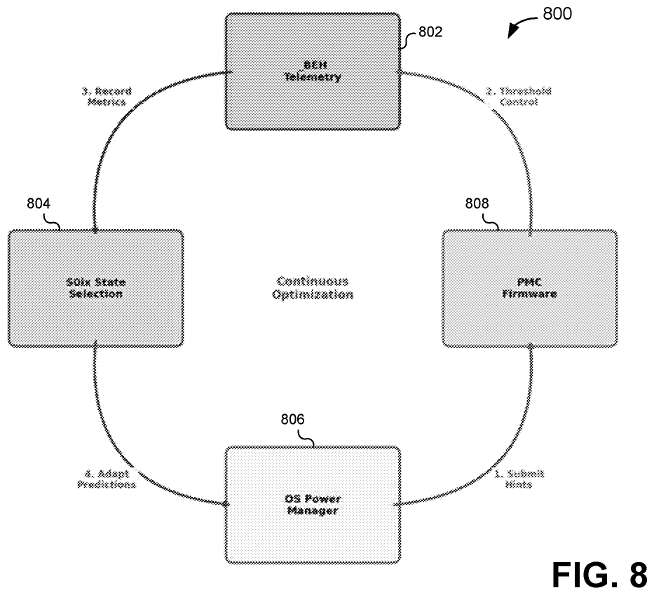

FIG. 8 illustrates a closed-loop continuous enhancement cycle 800 in various aspects. Cycle 800 comprises four nodes connected by directional arcs forming a circular flow. A BEH Telemetry node 802 collects effectiveness metrics from the PMC firmware. In stage 1 (“Submit Hints”), an OS Power Manager node 806 submits structured workload hints to a PMC Firmware node 808. In stage 2 (“Threshold Control”), the PMC Firmware node 808 applies hint-derived threshold adjustments and controls idle-state selection, feeding into a BEH Telemetry node 802 via the threshold control path. An S0ix State Selection node 804 represents the resulting idle-state outcomes. In stage 3 (“Record Metrics”), effectiveness metrics characterizing the quality of idle-state decisions are recorded by the BEH Telemetry node 802. In stage 4 (“Adapt Predictions”), the recorded metrics flow back to the OS Power Manager node 806, which adapts its prediction algorithms and hint-generation parameters based on the telemetry feedback, completing the loop.

In various aspects, the effectiveness data accumulated at the BEH Telemetry node 802 comprises: a total hint count (TotalHintsReceived) representing the number of hints processed; a correct prediction count (CorrectPredictions) representing hints where actual idle residency matched the prediction; a shallow-when-deep-needed count (ShallowWhenDeepNeeded) representing instances of unnecessary shallow residency; a deep-when-shallow-needed count (DeepWhenShallowNeeded) representing instances of unnecessary deep entry; and an estimated power savings metric (EstimatedPowerSavingsUw).

In various aspects, the effectiveness data further comprises dual-layer attribution fields enabling the OS to distinguish which validation layer was responsible for correct or incorrect decisions. These fields include: an OS confidence accuracy metric (OsConfidenceAccuracy) indicating the rate at which the HintConfidence correctly predicted outcome; a PMC override count (PmcOverrideCount) indicating the number of times the PMC's Layer 2 validation overrode the OS hint; a PMC override success rate (PmcOverrideSuccessRate) indicating the rate at which PMC overrides resulted in better residency outcomes; an OS-detected divergence count (DivergenceDetectedByOs) measuring Layer 1 self-awareness; and a PMC-detected divergence count (DivergenceDetectedByPmc) measuring the incremental value of Layer 2 validation.

In various aspects, the effectiveness data is consumed by a fleet-level analytics service for aggregate analysis across a population of devices. The analytics service identifies systematic patterns, such as particular workload types that consistently produce poor predictions, and generates updated classification parameters, multiplier values, or confidence-calibration adjustments that are distributed to the device population via firmware or OS policy updates.

### Implementation Considerations

The workload hint protocol may be implemented on any computing platform comprising a processor executing an OS and a power management controller responsible for idle-state selection. The protocol is not limited to any particular processor architecture, SoC vendor, OS, or power management controller implementation. In various aspects, the platform interface is implemented as an ACPI _DSM method with a vendor-specific UUID, the controller-accessible memory is PMC SRAM, and the telemetry interface is an ACPI_BEH method, as illustrated in FIGS. 2 and 3. In other aspects, vendor-specific or standardized interfaces may be used. The OS-side implementation may be integrated into an OS power framework such as an OS power framework (PoFx) or OS kernel platform power drivers (e.g., pmc_core, cpu_idle framework). A PMC-side implementation may be integrated into existing PMC firmware as an extension to the existing break-even threshold logic.

Unless explicitly specified, the term “transmit” encompasses both direct (point-to-point) and indirect transmission (via one or more intermediary points). Similarly, the term “receive” encompasses both direct and indirect reception.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The term “processor” as used herein may be understood as any kind of technological entity that allows handling of data. The data may be handled according to one or more specific functions that the processor execute. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

The following examples pertain to aspects of the configuration proposed herein.

Example 1 is a device. The device includes: a processor configured to execute an operating system, the operating system including an operating system power manager; a power management controller communicatively coupled to the processor, the power management controller configured to select among a plurality of idle states based on a break-even threshold; a platform interface providing a communication path from the operating system power manager to the power management controller; and a telemetry interface providing a return path from the power management controller to the operating system power manager, wherein the operating system power manager is configured to generate a structured workload hint encoding a plurality of workload-context parameters characterizing predicted idle behavior and to transmit the structured workload hint to the power management controller via the platform interface.

Example 2 includes the subject matter of Example 1, and the power management controller is configured to dynamically adjust the break-even threshold based on the plurality of workload-context parameters received in the structured workload hint.

Example 3 includes the subject matter of Example 2, and the power management controller is configured to dynamically adjust the break-even threshold by applying a multi-factor function to a base break-even threshold, the multi-factor function including a product of: an activity multiplier derived from one or more activity-related workload-context parameters; a battery multiplier derived from a battery context parameter; and a confidence weight derived from a confidence indicator, to produce a provisional break-even threshold.

Example 4 includes the subject matter of Example 3, and the power management controller is further configured to clamp the provisional break-even threshold to policy-configured bounds to produce an effective break-even threshold.

Example 5 includes the subject matter of any one of Examples 3 or 4, and when the confidence indicator falls below a policy threshold, the power management controller is further configured to blend the effective break-even threshold with a hardware-derived baseline threshold before committing a final threshold for idle-state selection.

Example 6 includes the subject matter of any one of Examples 3 to 5, and the activity multiplier is derived from an adaptive classification that maps combinations of workload-context parameter values to activity classes, each activity class being associated with a respective multiplier value, and wherein classification boundaries of the adaptive classification are updated based on effectiveness data received via the telemetry interface in a feedback-driven reclassification process.

Example 7 includes the subject matter of Example 6, and the feedback-driven reclassification process includes: determining, from the effectiveness data, a misclassification rate for each activity class, the misclassification rate representing a proportion of idle-state selections in which the selected idle state did not match the actual idle duration; and adjusting a classification boundary between an activity class and an adjacent activity class when the misclassification rate for the activity class exceeds a policy-configured threshold.

Example 8 includes the subject matter of any one of Examples 6 or 7, and the adaptive reclassification is performed at fleet scale by aggregating effectiveness telemetry from a population of devices via an analytics service, and updated classification boundaries are distributed to individual devices via at least one of a firmware update, an OS policy update, or a configuration parameter adjustment.

Example 9 includes the subject matter of any one of Examples 3 to 8, and the base break-even threshold is stored in a lookup table indexed by source-state and destination-state pairs, with distinct entries per hardware variant.

Example 10 includes the subject matter of any one of Examples 1 to 9, and the plurality of workload-context parameters include parameters spanning a plurality of conditions of system state, each condition capturing an aspect of system state observable by the operating system but not independently observable by the power management controller through hardware telemetry of the power management controller.

Example 11 includes the subject matter of Example 10, and the plurality of workload-context parameters include: a network activity indicator encoding a classification of network traffic intensity; a peripheral presence indicator encoding a type and activity state of attached peripheral devices; a display state indicator encoding a current state of a display subsystem; a battery context indicator encoding a power source and battery capacity state; a predicted idle duration including a forward-looking estimate derived from operating system scheduler state; a historical wake-interval average including a backward-looking rolling average of observed wake-to-wake intervals; and a confidence indicator including a self-assessment by the operating system power manager of reliability of the predicted idle duration.

Example 12 includes the subject matter of Example 11, and the network activity indicator is encoded as an unsigned integer classifying network traffic intensity among a set of levels including at least idle, low, and high.

Example 13 includes the subject matter of any one of Examples 11 or 12, and the peripheral presence indicator is encoded as an unsigned integer classifying attached peripheral activity among a set of levels including at least none, human interface device, storage idle, and active transfer.

Example 14 includes the subject matter of any one of Examples 11 to 13, and the display state indicator is encoded as an unsigned integer classifying display subsystem state among a set of levels including at least off, dimmed, and recently active.

Example 15 includes the subject matter of any one of Examples 11 to 14, and the battery context indicator is encoded as an unsigned integer classifying power source and remaining capacity among a set of levels including at least AC power, battery with greater than a first capacity threshold remaining, and battery with less than a second capacity threshold remaining.

Example 16 includes the subject matter of any one of Examples 11 to 15, and the predicted idle duration is a 32-bit unsigned integer representing the OS scheduler's predicted idle duration in milliseconds, derived from timer-coalescing queues and process-scheduling information.

Example 17 includes the subject matter of any one of Examples 11 to 16, and the historical wake-interval average is a 32-bit unsigned integer representing a moving average of recent wake-to-wake intervals in milliseconds.

Example 18 includes the subject matter of any one of Examples 11 to 17, and the confidence indicator is an unsigned integer representing a percentage value in a range of 1 to 100.

Example 19 includes the subject matter of any one of Examples 11 to 18, and the structured workload hint is a 16-byte packed data structure in which: byte 0 contains the network activity indicator; byte 1 contains the peripheral presence indicator; byte 2 contains the display state indicator; byte 3 contains the battery context indicator; bytes 4 through 7 contain the predicted idle duration; bytes 8 through 11 contain the historical wake-interval average; byte 12 contains the confidence indicator; and bytes 13 through 15 are reserved.

Example 20 includes the subject matter of any one of Examples 1 to 19, and the structured workload hint includes both a forward-looking predicted idle duration and a backward-looking historical wake-interval average as separate parameters, thereby enabling the power management controller to independently cross-validate the predicted idle duration against hardware-level wake-source telemetry of the power management controller using the historical wake-interval average as a reference signal.

Example 21 includes the subject matter of Example 20, and the operating system power manager is configured to perform a first validation layer by comparing the predicted idle duration against the historical wake-interval average and to reflect a result of the comparison in a confidence indicator transmitted as part of the structured workload hint, and wherein the power management controller is configured to perform a second validation layer using hardware-level telemetry including at least one of: latency tolerance reporting values from peripheral device endpoints; wake-source attribution data identifying which device endpoint triggered a recent wake event; and voltage rail status information.

Example 22 includes the subject matter of Example 21, and when the predicted idle duration and the historical wake-interval average diverge by more than a policy-configured divergence threshold, the operating system power manager reduces the confidence indicator to reflect reduced prediction reliability.

Example 23 includes the subject matter of any one of Examples 21 or 22, and the power management controller is configured to detect a change in a latency tolerance reporting value from a peripheral device endpoint that has not yet been notified to the operating system, and to attenuate the structured workload hint in response to the detected change.

Example 24 includes the subject matter of any one of Examples 20 to 23, and the dual-layer validation produces four decision quadrants: a first quadrant in which both the predicted idle duration and the historical wake-interval average indicate short idle windows, and the power management controller trusts the hint to select a shallow idle state; a second quadrant in which the predicted idle duration indicates short idle but the historical wake-interval average indicates long idle, and the power management controller may override the hint to select a deeper idle state; a third quadrant in which the predicted idle duration indicates long idle but the historical wake-interval average indicates short idle, and the power management controller discounts the hint and defers to hardware telemetry; and a fourth quadrant in which both indicate long idle windows, and the power management controller trusts the hint to select a deep idle state.

Example 25 includes the subject matter of any one of Examples 1 to 24, and the power management controller is further configured to generate effectiveness data characterizing quality of idle-state selections and to report the effectiveness data to the operating system power manager via the telemetry interface, and wherein the operating system power manager is configured to adjust one or more hint-generation parameters based on the effectiveness data to improve accuracy of subsequently generated structured workload hints.

Example 26 includes the subject matter of Example 25, and the effectiveness data includes: a total hint count representing a number of hints processed by the power management controller; a correct prediction count representing hints where actual idle residency matched the predicted idle behavior; a shallow-when-deep-needed count representing instances of unnecessary shallow idle residency; and a deep-when-shallow-needed count representing instances of unnecessary deep idle entry.

Example 27 includes the subject matter of any one of Examples 25 or 26, and the effectiveness data further includes an estimated power savings metric quantifying energy savings attributable to dynamically adjusted break-even thresholds relative to a static threshold baseline.

Example 28 includes the subject matter of any one of Examples 25 to 27, and the effectiveness data includes dual-layer attribution fields including: an OS confidence accuracy metric indicating a rate at which the confidence indicator correctly predicted idle-state outcome; a controller override count indicating a number of times the power management controller overrode the structured workload hint based on hardware-level telemetry; and a controller override success rate indicating a rate at which controller overrides resulted in improved idle-state residency outcomes compared to outcomes that would have resulted from following the structured workload hint.

Example 29 includes the subject matter of Example 28, and the dual-layer attribution fields further include: an OS-detected divergence count measuring a number of prediction-versus-history divergences detected by the operating system power manager and reflected in reduced confidence indicators; and a PMC-detected divergence count measuring a number of divergences detected by the power management controller via hardware-level telemetry that the operating system did not detect.

Example 30 includes the subject matter of any one of Examples 25 to 29, and the operating system power manager is configured to recalibrate a confidence-generation algorithm based on the effectiveness data to reduce a rate at which the confidence indicator fails to predict idle-state outcome.

Example 31 includes the subject matter of any one of Examples 25 to 30, and the effectiveness data is consumed by a fleet-level analytics service configured to aggregate effectiveness data from a plurality of devices and to generate updated hint-generation parameters for distribution to the plurality of devices.

Example 32 includes the subject matter of Example 31, and the updated hint-generation parameters include at least one of: updated classification boundaries for activity classes, updated multiplier values, and updated confidence-calibration adjustments, and the updated parameters are distributed via at least one of a firmware update, an OS policy update, or a configuration parameter adjustment.

Example 33 includes the subject matter of any one of Examples 1 to 32, and the device further includes a controller-accessible memory including a mailbox region, wherein the platform interface is configured to write the structured workload hint to the mailbox region, and wherein the power management controller is configured to read the structured workload hint from the mailbox region.

Example 34 includes the subject matter of Example 33, and the controller-accessible memory is static random-access memory (SRAM) within or accessible to the power management controller, and the mailbox region is a 16-byte region in the SRAM addressable via memory-mapped I/O.

Example 35 includes the subject matter of any one of Examples 33 or 34, and the platform interface writes the structured workload hint to the mailbox region via a memory-mapped I/O write.

Example 36 includes the subject matter of any one of Examples 1 to 35, and the platform interface includes an Advanced Configuration and Power Interface (ACPI) Device Specific Method (_DSM) identified by a vendor-specific universally unique identifier.

Example 37 includes the subject matter of any one of Examples 1 to 36, and the telemetry interface includes an ACPI method designated _BEH (Break-Even Hint) through which the power management controller exposes effectiveness metrics to the operating system power manager.

Example 38 includes the subject matter of any one of Examples 1 to 37, and the operating system power manager is configured to transmit the structured workload hint upon each idle entry transition of the operating system.

Example 39 includes the subject matter of any one of Examples 1 to 37, and the operating system power manager is configured to transmit the structured workload hint upon a determination that content of the structured workload hint has changed since a prior transmission.

Example 40 includes the subject matter of any one of Examples 1 to 37, and the operating system power manager is configured to transmit the structured workload hint upon expiration of a periodic timer, and to employ a combination of idle entry transmission during active workloads and periodic transmission during sustained idle periods.

Example 41 is a method for managing idle-state transitions in a computing device, the method being performed by a power management controller of the computing device and including: receiving, via a platform interface from an operating system power manager executing on a processor of the computing device, a structured workload hint encoding a plurality of workload-context parameters characterizing predicted idle behavior; computing a dynamically adjusted break-even threshold by applying a multi-factor function to a base break-even threshold using the plurality of workload-context parameters as inputs; selecting an idle-state depth from among a plurality of available idle states based on a comparison of an available idle window duration against the dynamically adjusted break-even threshold; and generating effectiveness data characterizing whether the selected idle-state depth matched the predicted idle behavior, and reporting the effectiveness data to the operating system power manager via a telemetry interface.

Example 42 includes the subject matter of Example 41, and computing the dynamically adjusted break-even threshold includes: determining an activity multiplier from one or more activity-related workload-context parameters; determining a battery multiplier from a battery context parameter; determining a confidence weight from a confidence indicator included in the structured workload hint; and computing a provisional threshold as a product of the base break-even threshold, the activity multiplier, the battery multiplier, and the confidence weight.

Example 43 includes the subject matter of Example 42, and computing the dynamically adjusted break-even threshold further includes clamping the provisional threshold to policy-configured bounds to produce an effective break-even threshold.

Example 44 includes the subject matter of any one of Examples 42 or 43, and when the confidence indicator is below a policy threshold, blending the effective break-even threshold with a hardware-derived baseline threshold to produce a final threshold for idle-state selection.

Example 45 includes the subject matter of any one of Examples 42 to 44, and determining the activity multiplier includes: classifying a combination of activity-related workload-context parameter values into an activity class using an adaptive classification; and mapping the activity class to a multiplier value.

Example 46 includes the subject matter of Example 45, and the method further includes updating classification boundaries of the adaptive classification based on accumulated effectiveness data in a feedback-driven reclassification process.

Example 47 includes the subject matter of Example 46, and updating the classification boundaries includes: determining, from the accumulated effectiveness data, a misclassification rate for each activity class; and adjusting a classification boundary between an activity class and an adjacent activity class when the misclassification rate exceeds a policy-configured threshold.

Example 48 includes the subject matter of any one of Examples 41 to 47, and the method further comprises performing a hardware-aware validation of the structured workload hint by cross-validating a predicted idle duration and a historical wake-interval average contained in the structured workload hint against hardware-level telemetry of the power management controller.

Example 49 includes the subject matter of Example 48, and the hardware-level telemetry includes latency tolerance reporting values from peripheral device endpoints indicating imminent wake constraints that the operating system has not yet been notified about.

Example 50 includes the subject matter of any one of Examples 48 or 49, and the hardware-level telemetry includes wake-source attribution data identifying which specific device endpoint triggered a recent wake event.

Example 51 includes the subject matter of any one of Examples 48 to 50, and the hardware-level telemetry includes voltage rail and power-domain status information.

Example 52 includes the subject matter of any one of Examples 41 to 51, and the effectiveness data includes dual-layer attribution fields enabling identification of whether the operating system or the power management controller was responsible for correct or incorrect idle-state selections, the dual-layer attribution fields including: an OS confidence accuracy metric; a controller override count; and a controller override success rate.

Example 53 includes the subject matter of any one of Examples 41 to 52, and the effectiveness data is transmitted to a fleet-level analytics service for aggregate analysis across a population of devices.

Example 54 includes the subject matter of any one of Examples 41 to 53, and receiving the structured workload hint is triggered by an idle entry transition of the operating system.

Example 55 includes the subject matter of any one of Examples 41 to 53, and receiving the structured workload hint is triggered by a determination by the operating system power manager that content of the structured workload hint has changed since a prior transmission.

Example 56 includes the subject matter of any one of Examples 41 to 53, and receiving the structured workload hint is triggered by expiration of a periodic timer.

Example 57 is a system including: a processor configured to execute an operating system, the operating system including an operating system power manager configured to monitor a plurality of system-state conditions and to generate a structured workload hint encoding a plurality of workload-context parameters characterizing predicted idle behavior, the structured workload hint including a confidence indicator reflecting a self-assessment of reliability of a predicted idle duration; a power management controller communicatively coupled to the processor, the power management controller configured to: receive the structured workload hint via a platform interface, dynamically adjust a break-even threshold for selecting among a plurality of idle states based on a multi-factor function of the plurality of workload-context parameters, and generate effectiveness data characterizing quality of idle-state selections made using the dynamically adjusted break-even threshold; and a telemetry interface via which the power management controller reports the effectiveness data to the operating system power manager, wherein the operating system power manager is further configured to adjust one or more hint-generation parameters based on the effectiveness data to improve accuracy of subsequently generated structured workload hints.

Example 58 includes the subject matter of Example 57, and the confidence indicator is generated by comparing the predicted idle duration against a historical wake-interval average maintained by the operating system power manager, and reducing the confidence indicator when the predicted idle duration and the historical wake-interval average diverge by more than a threshold amount.

Example 59 includes the subject matter of any one of Examples 57 or 58, and the power management controller is further configured to perform a hardware-aware validation of the structured workload hint using hardware-level telemetry including at least one of latency tolerance reporting values, wake-source attribution data, and voltage rail status, thereby implementing a dual-layer validation architecture in which the operating system provides a first validation layer and the power management controller provides a second validation layer.

Example 60 includes the subject matter of any one of Examples 57 to 59, and the multi-factor function includes a product of an activity multiplier, a battery multiplier, and a confidence weight applied to a base break-even threshold.

Example 61 includes the subject matter of Example 60, and the activity multiplier is derived from an adaptive classification whose classification boundaries are updated based on the effectiveness data in a feedback-driven reclassification process.

Example 62 includes the subject matter of any one of Examples 57 to 61, and the effectiveness data includes dual-layer attribution fields including an OS confidence accuracy metric, a controller override count, and a controller override success rate.

Example 63 includes the subject matter of any one of Examples 57 to 62, and the system further includes a fleet-level analytics service communicatively coupled to the operating system power manager, the fleet-level analytics service configured to aggregate effectiveness data from a plurality of instances of the system and to generate updated hint-generation parameters for distribution to the plurality of instances.

Example 64 includes the subject matter of any one of Examples 57 to 63, and the system further includes a controller-accessible memory including a mailbox region to which the platform interface writes the structured workload hint.

Example 65 includes the subject matter of any one of Examples 57 to 64, and the platform interface includes an ACPI Device Specific Method (_DSM) and the telemetry interface includes an ACPI_BEH method.

Example 66 includes the subject matter of any one of Examples 1 to 65, and can be implemented as a device, a method, a system, or any combination thereof, with corresponding structural elements recited as means for performing the respective functions.

What is claimed is:

1. A device comprising:
a processor configured to execute an operating system, the operating system comprising an operating system power manager;
a power management controller communicatively coupled to the processor, the power management controller configured to select among a plurality of idle states based on a break-even threshold;
a platform interface providing a communication path from the operating system power manager to the power management controller; and
a telemetry interface providing a return path from the power management controller to the operating system power manager,
wherein the operating system power manager is configured to generate a structured workload hint encoding a plurality of workload-context parameters characterizing predicted idle behavior and to transmit the structured workload hint to the power management controller via the platform interface.

2. The device of claim 1, wherein the power management controller is configured to dynamically adjust the break-even threshold based on the plurality of workload-context parameters received in the structured workload hint.

3. The device of claim 2, wherein the power management controller is configured to dynamically adjust the break-even threshold by applying a multi-factor function to a base break-even threshold, the multi-factor function comprising a product of:
an activity multiplier derived from one or more activity-related workload-context parameters;
a battery multiplier derived from a battery context parameter; and
a confidence weight derived from a confidence indicator, to produce a provisional break-even threshold.

4. The device of claim 3, wherein the power management controller is further configured to clamp the provisional break-even threshold to policy-configured bounds to produce an effective break-even threshold, and, when the confidence indicator falls below a policy threshold, to blend the effective break-even threshold with a hardware-derived baseline threshold before committing a final threshold for idle-state selection.

5. The device of claim 3, wherein the activity multiplier is derived from an adaptive classification that maps combinations of workload-context parameter values to activity classes, each activity class being associated with a respective multiplier value, and wherein classification boundaries of the adaptive classification are updated based on effectiveness data received via the telemetry interface in a feedback-driven reclassification process.

6. The device of claim 5, wherein the feedback-driven reclassification process comprises:
determining, from the effectiveness data, a misclassification rate for each activity class, the misclassification rate representing a proportion of idle-state selections in which the selected idle state did not match the actual idle duration; and
adjusting a classification boundary between an activity class and an adjacent activity class when the misclassification rate for the activity class exceeds a policy-configured threshold.

7. The device of claim 1, wherein the plurality of workload-context parameters comprise parameters spanning a plurality of conditions of system state, each condition capturing an aspect of system state observable by the operating system but not independently observable by the power management controller through hardware telemetry of the power management controller.

8. The device of claim 7, wherein the plurality of workload-context parameters comprise:
a network activity indicator encoding a classification of network traffic intensity;
a peripheral presence indicator encoding a type and activity state of attached peripheral devices;
a display state indicator encoding a current state of a display subsystem;
a battery context indicator encoding a power source and battery capacity state;
a predicted idle duration comprising a forward-looking estimate derived from operating system scheduler state;
a historical wake-interval average comprising a backward-looking rolling average of observed wake-to-wake intervals; and
a confidence indicator comprising a self-assessment by the operating system power manager of reliability of the predicted idle duration.

9. The device of claim 1, wherein the structured workload hint comprises both a forward-looking predicted idle duration and a backward-looking historical wake-interval average as separate parameters, thereby enabling the power management controller to independently cross-validate the predicted idle duration against hardware-level wake-source telemetry of the power management controller using the historical wake-interval average as a reference signal.

10. The device of claim 9, wherein the operating system power manager is configured to perform a first validation layer by comparing the predicted idle duration against the historical wake-interval average and to reflect a result of the comparison in a confidence indicator transmitted as part of the structured workload hint, and wherein the power management controller is configured to perform a second validation layer using hardware-level telemetry comprising at least one of: latency tolerance reporting values from peripheral device endpoints, wake-source attribution data identifying which device endpoint triggered a recent wake event, and voltage rail status information.

11. The device of claim 1, wherein the power management controller is further configured to generate effectiveness data characterizing quality of idle-state selections and to report the effectiveness data to the operating system power manager via the telemetry interface, and wherein the operating system power manager is configured to adjust one or more hint-generation parameters based on the effectiveness data to improve accuracy of subsequently generated structured workload hints.

12. The device of claim 11, wherein the effectiveness data comprises dual-layer attribution fields comprising:
an OS confidence accuracy metric indicating a rate at which the confidence indicator correctly predicted idle-state outcome;
a controller override count indicating a number of times the power management controller overrode the structured workload hint based on hardware-level telemetry; and
a controller override success rate indicating a rate at which controller overrides resulted in improved idle-state residency outcomes compared to outcomes that would have resulted from following the structured workload hint.

13. The device of claim 1, further comprising a controller-accessible memory comprising a mailbox region, wherein the platform interface is configured to write the structured workload hint to the mailbox region, and wherein the power management controller is configured to read the structured workload hint from the mailbox region.

14. The device of claim 1, wherein the operating system power manager is configured to transmit the structured workload hint upon at least one of: each idle entry transition of the operating system, a determination that content of the structured workload hint has changed since a prior transmission, and expiration of a periodic timer.

15. A method comprising:
receiving, via a platform interface from an operating system power manager executing on a processor of a computing device, a structured workload hint encoding a plurality of workload-context parameters characterizing predicted idle behavior;
computing a dynamically adjusted break-even threshold by applying a multi-factor function to a base break-even threshold using the plurality of workload-context parameters as inputs;
selecting an idle-state depth from among a plurality of available idle states based on a comparison of an available idle window duration against the dynamically adjusted break-even threshold; and
generating effectiveness data characterizing whether the selected idle-state depth matched the predicted idle behavior, and reporting the effectiveness data to the operating system power manager via a telemetry interface.

16. The method of claim 15, wherein computing the dynamically adjusted break-even threshold comprises:
determining an activity multiplier from one or more activity-related workload-context parameters;
determining a battery multiplier from a battery context parameter;
determining a confidence weight from a confidence indicator included in the structured workload hint;
computing a provisional threshold as a product of the base break-even threshold, the activity multiplier, the battery multiplier, and the confidence weight; and
clamping the provisional threshold to policy-configured bounds to produce the dynamically adjusted break-even threshold.

17. The method of claim 15, further comprising performing a hardware-aware validation of the structured workload hint by cross-validating a predicted idle duration and a historical wake-interval average contained in the structured workload hint against hardware-level telemetry of the power management controller comprising at least one of: latency tolerance reporting values from peripheral device endpoints, wake-source attribution data, and voltage rail status.

18. The method of claim 16, wherein determining the activity multiplier comprises:
classifying a combination of activity-related workload-context parameter values into an activity class using an adaptive classification;
mapping the activity class to a multiplier value; and
updating classification boundaries of the adaptive classification based on accumulated effectiveness data in a feedback-driven reclassification process.

19. A system comprising:
a processor configured to execute an operating system, the operating system comprising an operating system power manager configured to monitor a plurality of system-state conditions and to generate a structured workload hint encoding a plurality of workload-context parameters characterizing predicted idle behavior, the structured workload hint comprising a confidence indicator reflecting a self-assessment of reliability of a predicted idle duration;
a power management controller communicatively coupled to the processor, the power management controller configured to: receive the structured workload hint via a platform interface, dynamically adjust a break-even threshold for selecting among a plurality of idle states based on a multi-factor function of the plurality of workload-context parameters, and generate effectiveness data characterizing quality of idle-state selections made using the dynamically adjusted break-even threshold; and
a telemetry interface via which the power management controller reports the effectiveness data to the operating system power manager,
wherein the operating system power manager is further configured to adjust one or more hint-generation parameters based on the effectiveness data to improve accuracy of subsequently generated structured workload hints.

20. The system of claim 19, further comprising a fleet-level analytics service communicatively coupled to the operating system power manager, wherein the fleet-level analytics service is configured to aggregate effectiveness data from a plurality of instances of the system and to generate updated hint-generation parameters for distribution to the plurality of instances, and wherein the operating system power manager is configured to receive the updated hint-generation parameters and to incorporate the updated hint-generation parameters into subsequent structured workload hint generation.
